(19) United States
(12) Patent Application Publication
(10) Pub. No.: US 2019/0336383 A1
(43) Pub. Date: Nov. 7, 2019

(54) MOVEMENT ASSISTANCE SYSTEM AND METHOD THEREOF

(71) Applicant: NATIONAL CHIAO TUNG UNIVERSITY, Hsinchu City (TW)

(72) Inventors: Kai-Tai SONG, New Taipei City (TW); Yu-Lin CHIEN, Taichung City (TW)

(21) Appl. No.: 16/513,698

(22) Filed: Jul. 16, 2019

Related U.S. Application Data
(63) Continuation-in-part of application No. 14/957,620, filed on Dec. 3, 2015.

(51) Int. Cl. A61H 3/00; A61H 1/02; G06N 5/04

(52) U.S. Cl. CPC A61H 3/00; A61H 1/0262; G06N 5/048; A61H 2003/007; A61H 2201/165; A61H 2201/5071; A61H 2201/1642; A61H 2201/1207; A61H 2201/163; A61H 2201/5007

(57) ABSTRACT

A movement assistance method is provided to calculate center of pressure, a support torque, a gravity compensation torque, and a correction torque. The support torque is calculated according to a user external torque. The correction torque is obtained by multiplying the gravity compensation torque by an amendment scale. An assistive torque is calculated according to the support torque and the correction torque.

### RELATED APPLICATIONS

This application is a Continuation-in-part of U.S. application Ser. No. 14/957,620 filed on Dec. 3, 2015, which is herein incorporated by reference.

### BACKGROUND

### Field of Invention

The present disclosure relates to a movement assistance system and method thereof. More particularly, the present disclosure relates to movement assistance system and method thereof that can be applied for a lower limb exoskeleton.

### Description of Related Art

In recent years, the movement assistance system is increasing popular. The movement assistance system, such as lower limb exoskeleton, can be used for helping people to stand, walk or move with less strength while people wear it. Further, the lower limb exoskeleton also can be applied to support user to rehabilitate and to help for spiral injured patients. The lower limb exoskeleton works to enhance the user's strength of lower limb by a control system and mechanism.

It is important that the lower limb exoskeleton has to provide a safety and comfort mechanism to help user walk easily and keep their balance. Therefore, how to develop a lower limb exoskeleton to support elderly people to walk in balance becomes a problem to be solved in art.

### SUMMARY

Embodiments of the invention provide a movement assistance system including pressure sensors for detecting a plurality of pressure values and a processing circuit electrically connected to the pressure sensors. The processing circuit is configured to perform steps of: calculating a center of pressure according to the pressure values, wherein the center of pressure comprises an X-coordinate and a Y-coordinate; calculating a gravity scale according to the center of pressure, wherein the gravity scale is negatively correlated to an absolute value of the X-coordinate, and the gravity scale is negatively correlated to the Y-coordinate; calculating a user external torque according to a motor torque, an angular velocity, an angular acceleration, and at least one joint angle; calculating a support torque according to the user external torque and the angular velocity, wherein the support torque is equal to zero when a direction of the user external torque is not the same as a direction of the angular velocity; calculating a gravity compensation torque according to the at least one joint angle, and multiplying the gravity scale by the gravity compensation torque to obtain a correction torque; and calculating an assistive torque according to the support torque and the correction torque.

From another aspect, a movement assistance method is provided and includes the aforementioned steps performed by the processing circuit.

These and other features, aspects, and advantages of the present disclosure will become better understood with reference to the following description and appended claims. Through utilizing one embodiment described above, the disclosure obtains the center of pressure of the user so that it can improve user's balance during walking. This correction torque will help user to keep their balance when they tend to lose their balance.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a movement assistance system according to one embodiment of the present disclosure.

FIG. 2 is a block diagram of a movement assistance system according to one embodiment of the present disclosure.

FIG. 3 is a schematic diagram of pressure sensor placement for center of pressure measurement according to one embodiment of the present disclosure.

FIG. 4 and FIG. 5 are diagrams illustrating membership functions of the fuzzy control system in accordance with some embodiments.

FIG. 6 is a diagram illustrating posture of the lower limb exoskeleton in accordance with an embodiment.

FIG. 7 is a diagram illustrating a movement assistance method in accordance with an embodiment.

### DETAILED DESCRIPTION

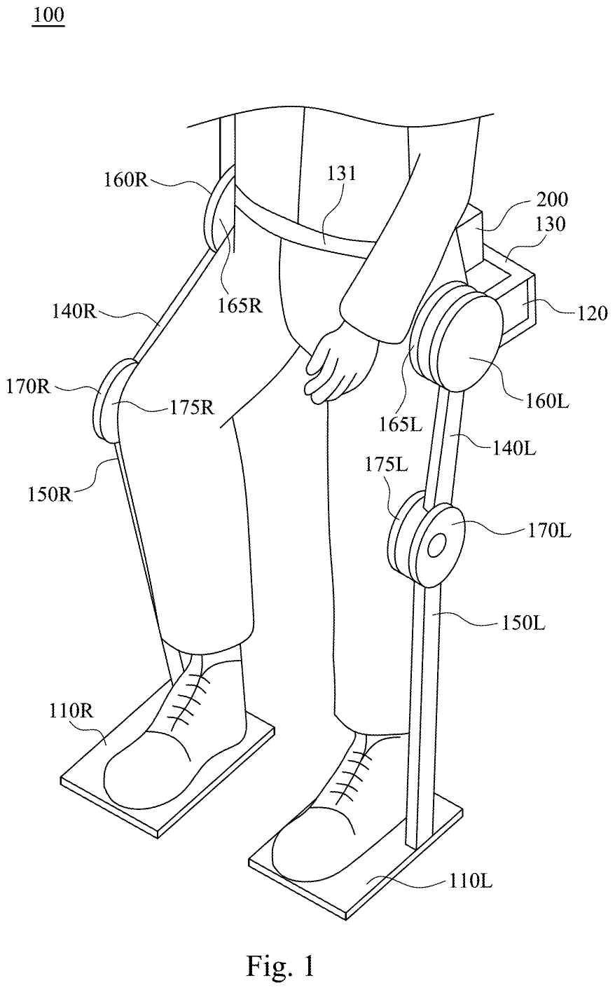

FIG. 1 is a schematic diagram of a movement assistance system 100 according to one embodiment of the present disclosure. As shown in FIG. 1, a movement assistance system 100 includes a battery 120 for supplying power; a waist part of support structure 130 with a buckle fastener 131 for supporting a waist of a user; upper parts of support structures 140L, 140R for supporting thighs of the user respectively; lower parts of support structures 150L, 150R for supporting shanks of the user respectively; hip joints 165L, 165R for mechanically connecting with the waist part of the support structure 130 and connecting with the upper part of support structures 140L, 140R respectively; knee joints 175L, 175R for mechanically connecting with the upper part of support structures 140L, 140R respectively. And, the knee joints 175L, 175R also mechanically and respectively connect with the lower part of support structures 150L, 150R. The knee motors 170L, 170R are used for controlling the knee joints 175L, 175R respectively. The hip motors 160L, 160R are used for controlling the hip joints 165L, 165R respectively. Lowest step board 110R and 110L mechanically connect with the support structures 150L, 150R respectively. Multiple pressure sensors are disposed on the lowest step boards 110L and 110R for detecting pressure values. The pressure sensors are electrically coupled to a processing circuit 200. The battery 120, the knee motors 170R, 170L, and the hip motors 160R, 160L are electronically coupled to the processing circuit 200. The processing circuit 200 can transmit a control signal for controlling the knee motor 170L, the knee motor 170R, the hip motor 160L and/or hip motor 160R.

In one embodiment, the length of the lower part of support structures 150L, 150R and the length of the upper part of support structures 140L, 140R can be adjusted longer or shorter according to the user's thighs and calves.

In one embodiment, the movement assistance system 100 can be implemented as only including one side mechanism for user to wear. For instance, user only wears the left part (e.g. processing circuit 200, battery 120, hip motor 160L, hip joint 165L, upper part of support structures 140L, knee motor 170L, knee joint 175L, lower part of support structure 150L, lowest step board 110L) of the movement assistance system 100 for supporting the left lower limb.

In one embodiment, the processing circuit 200 is further coupled to a sensor control board. The sensor control board is used for controlling the pressure sensors and receiving the data detected from the pressure sensors. In one embodiment, the processing circuit 200 is further coupled to motor controllers to control the operations of the knee motor 170L, the knee motor 170R, the hip motor 160L and/or the hip motor 160R. In one embodiment, these motor controllers are also coupled to motor encoders used for monitoring the status (e.g. angular velocity, angular acceleration, joint angle etc.) of the knee motor 170L, knee motor 170R, hip motor 160L and hip motor 160R. The motor encoders can transmit the status data of each motor to the processing circuit 200.

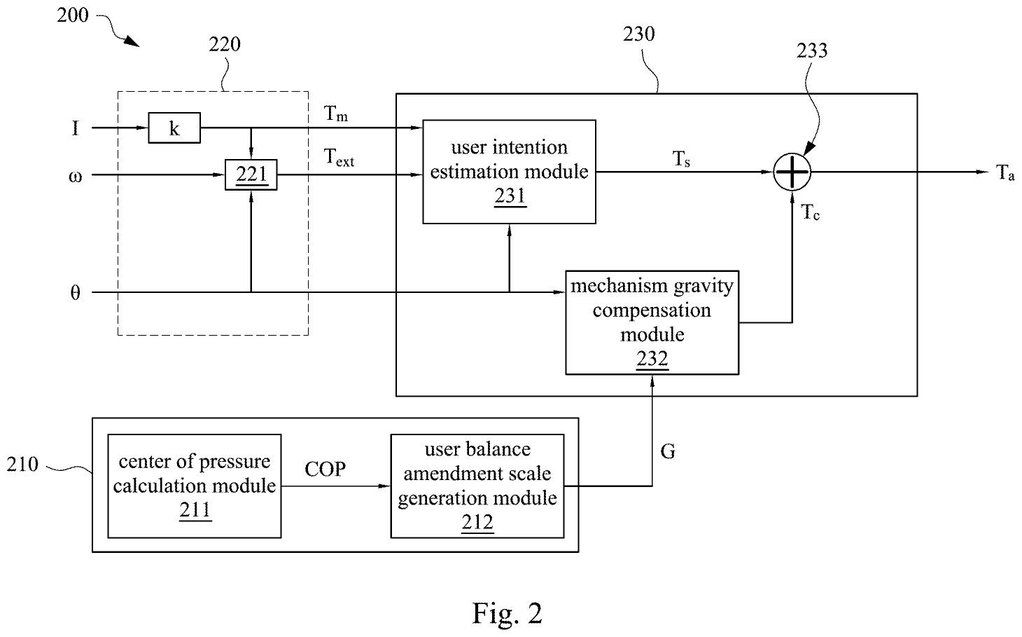

FIG. 2 is a block diagram of a movement assistance system according to one embodiment of the present disclosure. Referring to FIG. 2, the processing circuit 200 includes: a user balance gravity scale generation module 210, an external torque estimation module 220 and an assistive torque generation module 230. The user balance gravity scale generation module 210 is used for generating a gravity scale G according to the center of pressure (COP). The external torque estimation module 220 is used for measuring a motor current I and a joint angle θ for calculating a user external torque Tₑₓₜ and a motor torque Tₘ. The assistive torque generation module 230 is used for generating an assistive torque Tₐ according to the motor torque Tₘ, the user external torque Tₑₓₜ, the joint angle θ, and the gravity scale G. The assistive torque Tₐ is applied to at least one of the motors 170L, 170R, 160L, and 160R.

In one embodiment, the user balance gravity scale generation module 210, the external torque estimation module 220 and the assistive torque generation module 230 can be implemented individually or along with each other, and these modules can be implemented by a micro controller, a microprocessor, a digital signal processor, an application specific integrated circuit (ASIC), a firmware, a program, or a logical circuitry.

The movement assistance system 100 uses pressure sensors that are disposed under both of user's feet for calculating the COP of the user and to estimate user's balance state so that it can improve user's balance during walking. The estimation of the COP is used for generating the assistive torque Tₐ. This assistive torque Tₐ will help user to keep their balance when they tend to lose their balance. The movement assistance system 100 has the modular structures, the adjustable length of shank and the safe guard mechanism by calculating the assistive torque Tₐ. It makes that the movement assistance system 100 works smoothly, comfortable, and prevent from the unexpected. The technical feature related to the assistive torque Tₐ is further discussed later.

### [Calculation of Gravity Scale]

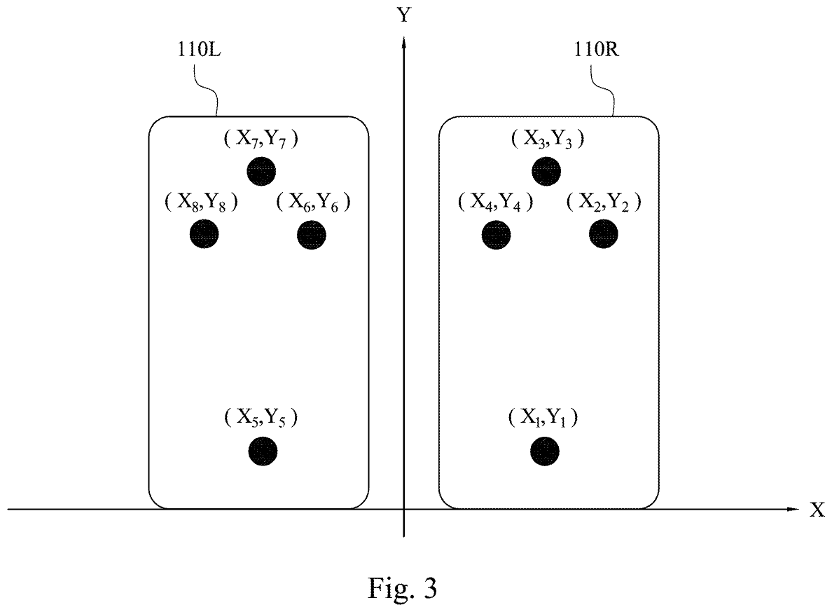

FIG. 3 is a schematic diagram of pressure sensor placement for center of pressure measurement according to one embodiment of the present disclosure. In the embodiment of FIG. 3, four pressure sensors are disposed on the lowest step board 110L, and four pressure sensors are disposed on the lowest step board 110R. The lowest step board 110L, 110R are disposed under both of user's feet. The pressure values detected by the pressure sensors are used to calculate a center of pressure (COP) representing the location of the center of gravity of the user. To be specific, each pressure value has an X-coordinate and a Y-coordinate. For example, a total of eight pressure values are written as (x₁, y₁), (x₂, y₂), (x₃, y₃), (x₄, y₄), (x₅, y₅), (x₆, yₑ), (x₇, y₇) and (x₈, yₑ). The COP also includes an X-coordinate and a Y-coordinate which are calculated according to the following equation (1).

$$\{ \begin{matrix}COP X = \frac{{X}_{n} \times {F}_{n}}{{Σ}_{n} {F}_{n}} \\ COP Y = \frac{{Y}_{n} \times {F}_{n}}{{Σ}_{n} {F}_{n}}\end{matrix} \qquad ( 1 )$$

COPX denotes the X-coordinate of the COP. COPY denotes the Y-coordinate of the COP. Fₙ denotes the magnitude of n^{th} pressure value where n is an integer from 1 to 8 in this example. In the embodiment, the middle between the lowest step board 110L and 110R is set to be COPX=0, and the rear edges of the lowest step board 110L and 110R are set to be COPY=0, but the invention is not limited thereto.

The COP is used to calculate the gravity scale G. It is designed that the gravity scale is negatively correlated to the absolute value of COPX, and the gravity scale is negatively correlated to COPY. In some embodiments, the gravity scale is obtained by substituting COPX and COPY into a function which may be linear function, a polynomial function, an exponential function, or the combination thereof which is not limited in the invention.

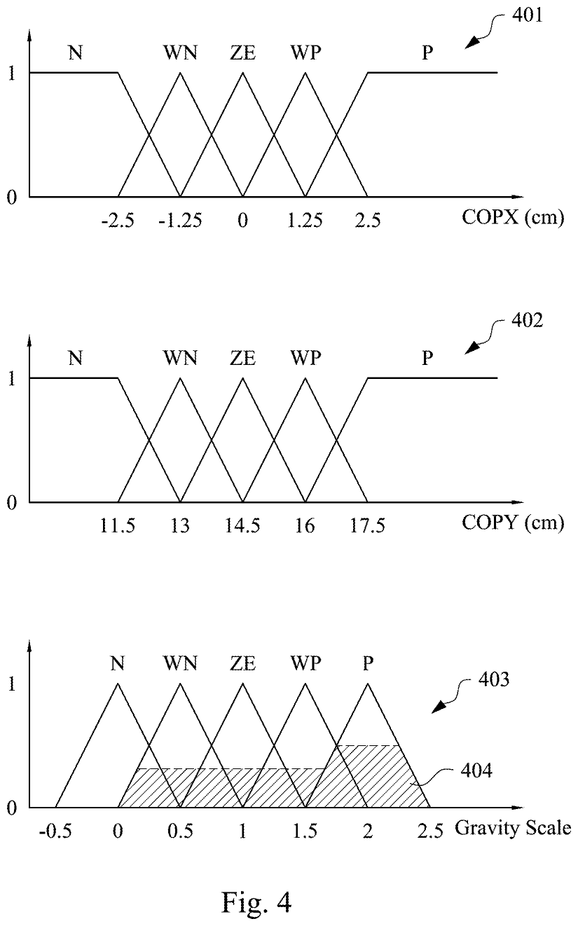

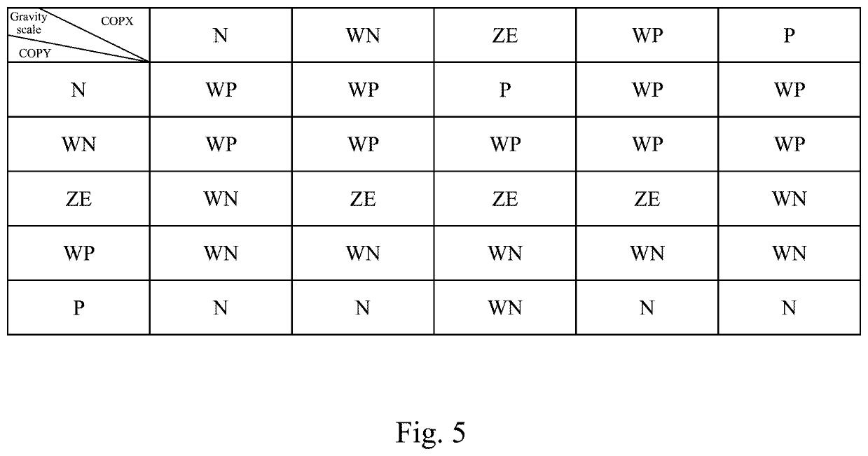

In some embodiment, the gravity scale is calculated by a fuzzy control system. FIG. 4 and FIG. 5 are diagrams illustrating membership functions of the fuzzy control system in accordance with some embodiments. First, the COP is converted into fuzzy values according to the membership functions 401 and 402 corresponding to balance states of “N”, “WN”, “ZE”, “WP”, and “P” indicating shifting degrees of negative, weakly negative, zero shift, weakly positive and positive respectively. Herein, “N” and “WN” represent that the user falls backward, and “P” and “WP” represent that the user falls forward. From another aspect, the balance states are determined according to the following equations (2) and (3) based on the membership functions 401 and 402. Note that the balance states can be overlapped since the fuzzy control system is used.

$$\begin{matrix}\{ \begin{matrix}N & if COPX < - 1.25 \\ WN & if - 2.5 < COPX < 0 \\ ZE & if - 1.25 < COPX < 1.25 \\ WP & if 0 < COPX < 2.5 \\ P & if COPX > 1.25\end{matrix} & ( 2 ) \\ \{ \begin{matrix}N & if COPY < 13 \\ WN & if 11.5 < COPY < 14.5 \\ ZE & if 13 < COPY < 16 \\ WP & if 14.5 < COPY < 17.5 \\ P & if COPY > 1.6\end{matrix} & ( 3 )\end{matrix}$$

For example, if COPX=−1.25, then the fuzzy value of “WN” for COPX is 1; if COPY=16, then the fuzzy value of “WP” for COPY is 1, and so on. Note that other types of membership functions may be adopted in other embodiments.

FIG. 5 is a diagram illustrating fuzzy rules in accordance with an embodiment. FIG. 5 shows a table with multiple fuzzy rules. For example, the second row and the second column of the table indicate the fuzzy rule of “if COPX is N and COPY is N, then the gravity scale is WP”, and so on. It is designed that COPY is negatively correlated to the gravity scale. That is, the gravity scale is increased when COPY is N or WN; and the gravity scale is decreased when COPY is P and WP. In addition, the absolute value of COPX is negatively correlated to the gravity scale. Each fuzzy rule is evaluated to generate a result (e.g. the gravity scale is WP). All the results of the fuzzy rules are combined according to a gravity membership function 403 to obtain an inference result. For example, the inference result is shown as a distribution 404 in FIG. 4. In some embodiments, the results are combined by Max-Min inference, but the invention is not limited thereto. Next, a defuzzification process is performed according to the inference result to calculate the gravity scale. In some embodiments, center of mass of the distribution 404 is adopted, but other defuzzification processes may be adopted in other embodiments. Note that people in the art should appreciate the fuzzy control system, and therefore the operations thereof are not described in detail herein. The book of “A Neuro-Fuzzy Synergism to Intelligent System” by C. T. Lin and C. S. George Lee, Pretice-Hall, 1996 is referred as a reference herein.

### [Calculation of the User External Torque]

Referring to FIG. 2, the user external torque Tₑₓₜ is calculated according to the motor torque Tₘ, the angular velocity ω, and at least one joint angle θ. In detail, the torque applied to a joint (e.g. the knee joint 175L, 175R or the hip joint 165L, 165R) complies with the basic physical principle written as the following equation (4).

Tₑₓₜ+Tₘ=Jα+Dω+T_{g}+f (4)

J denotes motion inertia of the joint. α denotes the angular acceleration of the joint. D denotes a damping. ω is the angular velocity of the joint. T_{g} denotes a gravity compensation torque. f denotes a friction force. The angular acceleration a and the angular velocity ω are obtained by reading the motor encoder. The motor torque Tₘ is calculated by multiplying the current I of the motor with a torque constant K as the following equation (5).

Tₘ=I×K (5)

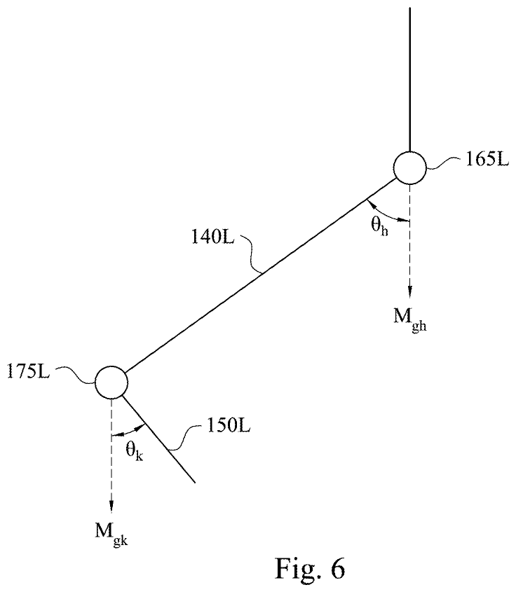

The motion inertia J, the damping D, the gravity compensation torque T_{g}, and the friction force f are calculated by a dynamic model 221. To be specific, the gravity compensation torque T_{g} is affected by the posture of the movement assistance system 100. Therefore, the posture is analyzed first as shown in FIG. 6 where the heap joint 165L, the upper part of the support structure 140L (i.e. the thigh), the knee joint 175L, and the lower part of support structure 150L (i.e. the shank) are taken as an example. A torque T_{gh} applied to the heap joint 165L is written as the following equation (6).

T_{gh}=Lₕ×M_{gh}×sin(θₕ)+Lₖ×M_{gk}×Sin(θₖ) (6)

Lₕ is the length of the support structure 140L. Lₖ is the length of the support structure 150L. M_{gh} is the gravity force applied to the heap joint 165L. M_{gk} is the gravity force applied to the knee joint 175L. θₕ is the joint angle between the support structure 140L and the force M_{gh}, and the angle θₕ is positive when the thigh is lifted. θₖ is the joint angle between the support structure 150L and the force M_{gk}, and the angle θₖ is positive when the shank is lifted. The equation (6) is simplified as the following equation (7) where A and B are constants.

T_{gh}=A×sin(θₕ)+B×Sin(θₖ) (7)

The following equation (8) is obtained by substituting the equations (5) and (7) into the equation (4).

T_{ext_h}+Iₕ×Kₕ=Jₕαₕ+Dₕωₕ+A×sin(θₕ)+B×Sin(θₖ)+fₕ×sign(ωₕ) (8)

The subscripts of “h” in the equation (8) means “heap”. That is, the equation (8) is used to calculate the parameters corresponding to the heap joint 165L. Note that the parameters Jₕ, Dₕ, A, B, and fₕ are unknown. In the dynamic system 221, a number of simulations are performed to obtain sensed parameters so as to calculate the unknown parameters. The system 100 is simulated without the user, and therefore the torque T_{ext_h} is removed from the equation (8). After the system 100 is simulated n times where n is a positive greater than 5, the corresponding parameters Iₕ, αₕ, θₕ, θₖ, and ωₕ are sensed. Accordingly, the following equation (9) is obtained.

$$[ \begin{matrix}K \times {i}_{h 1} \\ ⋮ \\ K \times {i}_{hn}\end{matrix} ] = [ \begin{matrix}{α}_{h 1} & {ω}_{h 1} & sin ( {θ}_{h 1} ) & Sin ( {θ}_{k 1} ) & sign ( {ω}_{h 1} ) \\ ⋮ & ⋮ & ⋮ & ⋮ & ⋮ \\ {α}_{hn} & {ω}_{hn} & sin ( {θ}_{hn} ) & Sin ( {θ}_{k 1} ) & sign ( {ω}_{hn} )\end{matrix} ] [ \begin{matrix}{J}_{h}^{′} \\ {D}_{h}^{′} \\ A \\ B \\ {f}_{h}\end{matrix} ] \qquad ( 9 )$$

The unknown parameters J′ₕ, D′ₕ, A, B, fₕ can be calculated by an optimization algorithm (e.g. by minimizing the least square error) which is not limited in the invention. Note that the equation (9) is simulated without the user, and therefore J′ₕ and D′ₕ have to be converted into the situation in which the system 100 moves with the user. In some embodiments, J′ₕ and D′ₕ are converted into Jₕ and Dₕ by the following equations (10) and (11).

$$\begin{matrix}{J}_{h} = {J}_{h}^{′} \times \frac{M + H}{M} & ( 10 ) \\ {D}_{h} = {D}_{h}^{′} \times \frac{M + H}{M} & ( 11 )\end{matrix}$$

M denotes the weight of the system 100. H denotes the weight of the lower limb of the user. After the parameters Jₕ, Dₕ, A, B, fₕ are calculated, the user external torque T_{ext_h} is calculated by the following equation (12).

T_{ext_h}=Jₕαₕ+Dₕωₕ+A×sin(θₕ)+B×Sin(θₖ)+fₕ×sign(ωₕ)−Iₕ×Kₕ (12)

The user external torque applied to the knee joint is calculated in the same way. The difference is that the gravity force M_{gh} applied on the heap joint is removed from the equation (6). Accordingly, the user external torque T_{ext_k} for the knee joint is calculated by the following equation (13) where the subscripts of “k” mean “knee”.

T_{ext_k}=Jₖαₖ+Dₖωₖ+A′×sin(θₖ)+fₖ×sign(ωₖ)−Iₖ×Kₖ (13)

### [Calculation of the Assistive Torque]

Referring to FIG. 2, the assistive torque Tₐ includes three parts. The first one is a support torque Tₛ provided to boost the user's walking. The second one is a gravity compensation torque used to cancel out the extra gravity effect of the system 100. The third one is a correction torque to help the user to keep balance when tending to lose balance or walking on a ramp.

The support torque is described herein. The support torque is designed to recognize the user's intention so that the user can walk more easily. The angular velocity of the motor and the direction of the user external torque are used to recognize the user's intention. If the direction of the user external torque is the same as the direction of the angular velocity, it indicates that the user does not resist the motor, and therefore the support torque is provided. In contrast, if the direction of the user external torque is not the same as the direction of the angular velocity, the support torque is set to zero. In addition, the support torque is provided only when the user external torque is greater than a lower bound for the sake of user's comfort. Moreover, the support torque is provided only when the user wants to lift his legs (i.e. the user external torque is positive) because the gravity would help the user put down the leg. In some embodiments, a user intention estimation module 231 calculates the support torque by the following equation (14).

$$\{ \begin{matrix}{T}_{s} = ( {T}_{ext} - {L}_{B} ) \times S + {L}_{B} if {T}_{ext} > {L}_{B} and {T}_{ext} \times ω > 0 \\ {T}_{s} = 0 otherwise\end{matrix} \qquad ( 14 )$$

Tₛ denotes the support torque. L_{B} denotes the lower bound of the support torque. S denotes a scaling factor in a range from 0 to 1.

The gravity compensation torque is described herein. The gravity compensation torque is designed based on the analysis of the gravity effect which has been described in FIG. 6. In the embodiment, the gravity compensation torque T_{gh} for the heap joint is written as the following equation (15), and the gravity compensation torque T_{gk} for the knee joint is written as the following equation (16).

T_{gh}=A×sin(θₕ)+B×Sin(θₖ)+fₕ×sign(ωₕ) (15)

T_{gk}=A′×sin(θₖ)+fₕ×sign(ωₖ) (16)

The correction torque is described herein. The correction torque is only applied to the heap joint because the balance state of the user is changed mainly by the direction of the thigh. If the correction torque is applied to the shank, the user may be unstable. In addition, the magnitude of the correction torque is proportional to the gravity compensation torque in order to be adaptive to the user's posture. The correction torque is also affected by the gravity scale. As described above, the gravity scale indicates the extent and the direction of the shift of center of gravity. When the user climbs, the user's center of gravity is shifted backward, and therefore a positive torque is needed to help the user lift the leg and walk forward. When the user walks downhill, the user's center of gravity is shifted forward, and therefore a negative torque is needed to help the user put down the leg and walk forward. Accordingly, a mechanism gravity compensation module 232 multiplies the gravity scale G by the gravity compensation torque to generate the correction torque. In the embodiments, the correction torque is calculated by the following equation (17).

T_{c}=(G−1)×T_{gh} (17)

Note that −1≤(G−1)≤1, and therefore the sign of the correction torque is also affected by the gravity scale. In one embodiment, the assistive torque generation module 230 includes an assistive controller module 233 for receiving the support torque Tₛ and the correction torque T_{c}, and generating the assistive torque Tₐ according to the support torque Tₛ and the correction torque T_{c}. In one embodiment, the assistive torque generation module 233 can add the support torque Tₛ to the correction torque T_{c} for generating the assistive torque Tₐ. For example, the assistive torque Tₐₕ for the heap joint is calculated by the following equation (18). The assistive torque Tₐₖ for the knee joint is calculated by the following equation (19).

$$\begin{matrix}\{ \begin{matrix}{T}_{ah} = ( {T}_{ext \_ h} - {L}_{Bh} ) \times S + {L}_{Bh} + {T}_{c} + {f}_{h} if {T}_{ext \_ h} > {L}_{Bh} and \\ {T}_{ext \_ h} \times {ω}_{h} > 0 \\ {T}_{ah} = {T}_{c} + {f}_{h} otherwise\end{matrix} & ( 18 ) \\ \{ \begin{matrix}{T}_{ak} = ( {T}_{ext \_ k} - {L}_{Bk} ) \times S + {L}_{Bk} + {T}_{gk} + {f}_{k} if {T}_{ext \_ k} > {L}_{Bk} and \\ {T}_{ext \_ k} \times {ω}_{k} > 0 \\ {T}_{ak} = {T}_{gk} + {f}_{k} otherwise\end{matrix} & ( 19 )\end{matrix}$$

Note that the equations (17) to (19) can be generalized as the following equations (20) and (21).

$$\begin{matrix}\{ \begin{matrix}{T}_{a} = ( {T}_{ext} - {L}_{B} ) \times S + {L}_{B} + {T}_{c} + f if {T}_{ext} > {L}_{B} and {T}_{ext} \times ω > 0 \\ {T}_{a} = {T}_{c} + f otherwise\end{matrix} & ( 20 ) \\ {T}_{c} = ( G - 1 ) \times {T}_{g} & ( 21 )\end{matrix}$$

As mentioned above, the support torque Tₛ is based on user external torque Tₑₓₜ. The gravity compensation torque T_{g} is designed based on the posture of lower limb exoskeleton. The correction torque T_{c} is designed based on user balance state to help the user to keep balance when tend to lose balance or walking on a ramp. These torques are combined to provide the assistive torque Tₐ of each join of the exoskeleton to assist the user during walking. Through utilizing at least one embodiment described above, the movement assistance system 100 can increases user's strength and keeps his/her balance during walking. It can be used for walking assistance as well as for rehabilitation.

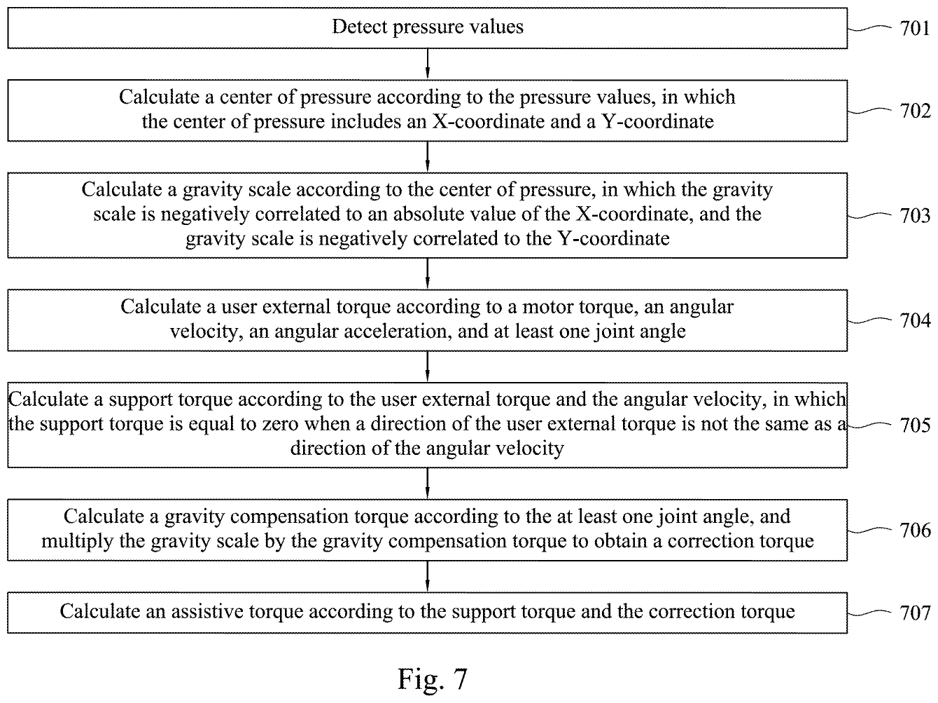

FIG. 7 is a diagram illustrating a movement assistance method in accordance with an embodiment. Referring to FIG. 7, in step 701, pressure values are detected. In step 702, a center of pressure is calculated according to the pressure values, in which the center of pressure includes an X-coordinate and a Y-coordinate. In step 703, a gravity scale is calculated according to the center of pressure, in which the gravity scale is negatively correlated to an absolute value of the X-coordinate, and the gravity scale is negatively correlated to the Y-coordinate. In step 704, a user external torque is calculated according to a motor torque, an angular velocity, an angular acceleration, and at least one joint angle. In step 705, a support torque is calculated according to the user external torque and the angular velocity, in which the support torque is equal to zero when a direction of the user external torque is not the same as a direction of the angular velocity. In step 706, a gravity compensation torque is calculated according to the at least one joint angle, and the gravity scale is multiplied by the gravity compensation torque to obtain a correction torque. In step 707, an assistive torque is calculated according to the support torque and the correction torque. Each step in FIG. 7 has been described in detail above, and therefore the description will not be repeated. Note that the sequence of the steps 701-707 may be modified. For example, the steps 701-703 may be performed after the step 704 is performed.

Although the present disclosure has been described in considerable detail with reference to certain embodiments thereof, other embodiments are possible. Therefore, the scope of the appended claims should not be limited to the description of the embodiments contained herein.

What is claimed is:

1. A movement assistance system, comprising:
a plurality of pressure sensors for detecting a plurality of pressure values; and
a processing circuit electrically connected to the plurality of pressure sensors and configured to perform a plurality of steps:
calculating a center of pressure according to the plurality of pressure values, wherein the center of pressure comprises an X-coordinate and a Y-coordinate;
calculating a gravity scale according to the center of pressure, wherein the gravity scale is negatively correlated to an absolute value of the X-coordinate, and the gravity scale is negatively correlated to the Y-coordinate;
calculating a user external torque according to a motor torque, an angular velocity, an angular acceleration, and at least one joint angle;
calculating a support torque according to the user external torque and the angular velocity, wherein the support torque is equal to zero when a direction of the user external torque is not the same as a direction of the angular velocity;
calculating a gravity compensation torque according to the at least one joint angle, and multiplying the gravity scale by the gravity compensation torque to obtain a correction torque; and
calculating an assistive torque according to the support torque and the correction torque.

2. The movement assistance system of claim 1, further comprising:
a lowest step board, wherein the pressure sensors are disposed on the lowest step board.

3. The movement assistance system of claim 2, wherein the step of calculating the center of pressure according to the pressure values is performed according to an equation (1):
$$\{ \begin{matrix}COP X = \frac{{X}_{n} \times {F}_{n}}{{Σ}_{n} {F}_{n}} \\ COP Y = \frac{{Y}_{n} \times {F}_{n}}{{Σ}_{n} {F}_{n}}\end{matrix} \qquad ( 1 )$$
wherein COPX denotes the X-coordinate of the center of pressure, COPY denotes the Y-coordinate of the center of pressure, Fₙ denotes a n^{th} pressure value of the pressure values, Xₙ denotes a X-coordinate of the n^{th} pressure value, and Yₙ denotes a Y-coordinate of the n^{th} pressure value.

4. The movement assistance system of claim 3, wherein the gravity scale is calculated by a fuzzy control system.

5. The movement assistance system of claim 3, wherein the step of calculating the user external torque according to the motor torque, the angular velocity, the angular acceleration, and the at least one joint angle is performed according to an equation (2):
Tₑₓₜ=Jα+Dω+T_{g}+f−Tₘ (2)
wherein Tₑₓₜ denotes the external torque, J denotes motion inertia of a joint, α denotes the angular acceleration, D denotes a damping, ω is the angular velocity, T_{g} denotes the gravity compensation torque, f denotes a friction force, and Tₘ denotes the motor torque.

6. The movement assistance system of claim 5, wherein the step of calculating the support torque according to the user external torque and the angular velocity is performed according to an equation (3):
$$\{ \begin{matrix}{T}_{s} = ( {T}_{ext} - {L}_{B} ) \times S + {L}_{B} if {T}_{ext} > {L}_{B} and {T}_{ext} \times ω > 0 \\ {T}_{s} = 0 otherwise\end{matrix} \qquad ( 3 )$$
wherein Tₛ denotes the support torque, L_{B} denotes a lower bound of the support torque, and S denotes a scaling factor.

7. The movement assistance system of claim 6, wherein the step of calculating the assistive torque is performed according to equations (4) and (5):
$$\begin{matrix}\{ \begin{matrix}{T}_{a} = ( {T}_{ext} - {L}_{B} ) \times S + {L}_{B} + {T}_{c} + f if {T}_{ext} > {L}_{B} and {T}_{ext} \times ω > 0 \\ {T}_{a} = {T}_{c} + f otherwise\end{matrix} & ( 4 ) \\ {T}_{c} = ( G - 1 ) \times {T}_{g} & ( 5 )\end{matrix}$$
wherein G denotes the gravity scale in a range from 0 to 2.

8. The movement assistance system of claim 1, further comprising:
a battery for supplying a power;
a waist part of support structure for supporting a waist of a user;
an upper part of support structure for supporting a thigh of the user;
a lower part of support structure for supporting a calf of the user;
a hip joint for mechanically connecting with the waist part of support structure and the upper part of support structure;
a knee joint for mechanically connecting with the upper part of support structure and the lower part of support structure;
a knee motor for controlling the knee joint; and
a hip motor for controlling the hip joint;
wherein the battery, the knee motor, and the hip motor are electronically coupled to the processing circuit.

9. A movement assistance method for a movement assistance system, the movement assistance method comprising:
detecting, by a plurality of pressure sensors, a plurality of pressure values;
calculating a center of pressure according to the plurality of pressure values, wherein the center of pressure comprises an X-coordinate and a Y-coordinate;
calculating a gravity scale according to the center of pressure, wherein the gravity scale is negatively correlated to an absolute value of the X-coordinate, and the gravity scale is negatively correlated to the Y-coordinate;
calculating a user external torque according to a motor torque, an angular velocity, an angular acceleration, and at least one joint angle;
calculating a support torque according to the user external torque and the angular velocity, wherein the support torque is equal to zero when a direction of the user external torque is not the same as a direction of the angular velocity;
calculating a gravity compensation torque according to the at least one joint angle, and multiplying the gravity scale by the gravity compensation torque to obtain a correction torque; and
calculating an assistive torque according to the support torque and the correction torque.

10. The movement assistance method of claim 9, wherein the step of calculating the center of pressure according to the pressure values is performed according to an equation (1):
$$\{ \begin{matrix}COP X = \frac{{X}_{n} \times {F}_{n}}{{Σ}_{n} {F}_{n}} \\ COP Y = \frac{{Y}_{n} \times {F}_{n}}{{Σ}_{n} {F}_{n}}\end{matrix} \qquad ( 1 )$$
wherein COPX denotes the X-coordinate of the center of pressure, COPY denotes the Y-coordinate of the center of pressure, Fₙ denotes a n^{th} pressure value of the pressure values, Xₙ denotes a X-coordinate of the n^{th} pressure value, and Yₙ denotes a Y-coordinate of the n^{th} pressure value.

11. The movement assistance method of claim 10, wherein the step of calculating the user external torque according to the motor torque, the angular velocity, the angular acceleration, and the at least one joint angle is performed according to an equation (2):
Tₑₓₜ=Jα+Dω+T_{g}+f−Tₘ (2)
wherein Tₑₓₜ denotes the external torque, J denotes motion inertia of a joint, α denotes the angular acceleration, D denotes a damping, ω is the angular velocity, T_{g} denotes the gravity compensation torque, f denotes a friction force, and Tₘ denotes the motor torque.

12. The movement assistance method of claim 11, wherein the step of calculating the support torque according to the user external torque and the angular velocity is performed according to an equation (3):
$$\{ \begin{matrix}{T}_{s} = ( {T}_{ext} - {L}_{B} ) \times S + {L}_{B} if {T}_{ext} > {L}_{B} and {T}_{ext} \times ω > 0 \\ {T}_{s} = 0 otherwise\end{matrix} \qquad ( 3 )$$
wherein Tₛ denotes the support torque, L_{B} denotes a lower bound of the support torque, and S denotes a scaling factor.

13. The movement assistance method of claim 12, wherein the step of calculating the assistive torque is performed according to equations (4) and (5):
$$\begin{matrix}\{ \begin{matrix}{T}_{a} = ( {T}_{ext} - {L}_{B} ) \times S + {L}_{B} + {T}_{c} + f if {T}_{ext} > {L}_{B} and {T}_{ext} \times ω > 0 \\ {T}_{a} = {T}_{c} + f otherwise\end{matrix} & ( 4 ) \\ {T}_{c} = ( G - 1 ) \times {T}_{g} & ( 5 )\end{matrix}$$
wherein G denotes the gravity scale in a range from 0 to 2.
